(19) United States
(12) Patent Application Publication
(10) Pub. No.: US 2025/0028287 A1
(43) Pub. Date: Jan. 23, 2025

(54) Real Time Control Using an Isolated Controller

(71) Applicant: Woodward, Inc., Fort Collins, CO (US)

(72) Inventors: Dave Rubenthaler, Fort Collins, CO (US); Bryan W. Guild, Fort Collins, CO (US); Raja Damerla, Fort Collins, CO (US); Tena K. Britt, Loveland, CO (US)

(21) Appl. No.: 18/223,776

(22) Filed: Jul. 19, 2023

(51) Int. Cl. G05B 9/02

(52) U.S. Cl. CPC G05B 9/02

(57) ABSTRACT

The present disclosure involves systems, software, and computer implemented methods for controlling machinery. The system can include a sensor configured to measure an operating characteristic of a machine, and a safety controller in communication with the sensor. The safety controller can include a dedicated boundary processor and be in communication with a control processor through the boundary processor that isolates operations of the control processor form the safety controller. The safety controller can be configured to receive measurement data from the sensor, perform signal conditioning on the measurement data to generate a conditioned sample, analyze the conditioned sample to determine whether to take a safety action, and send the conditioned sample to the boundary processor for transmission to the control processor. The control processor can be configured to perform operations including receiving the conditioned sample and controlling one or more operations of the machine based on the conditioned sample.

### TECHNICAL FIELD

This disclosure generally relates to real time control of machinery

### BACKGROUND

Turbines and other machinery are widely used in various industrial and commercial applications to generate electricity or mechanical power. These machines often operate in harsh conditions or situations where reliability is paramount. Thus, safety control systems are often implemented to enable emergency reactions in the event of an anomaly.

### SUMMARY

The present disclosure involves systems, software, and computer implemented methods for controlling machinery. The system can include a sensor configured to measure an operating characteristic of a machine, and a safety controller in communication with the sensor. The safety controller can include a dedicated boundary processor and be in communication with a control processor through the boundary processor that isolates operations of the control processor form the safety controller. The safety controller can be configured to receive measurement data from the sensor, perform signal conditioning on the measurement data to generate a conditioned sample, analyze the conditioned sample to determine whether to take a safety action, and send the conditioned sample to the boundary processor for transmission to the control processor. The control processor can be configured to perform operations including receiving the conditioned sample and controlling one or more operations of the machine based on the conditioned sample.

Implementations can optionally include one or more of the following features.

In some instances, the sensor is triggered by a timer to perform a measurement periodically.

In some instances, the control processor is configured to wait to control one or more operations of the machine until a next trigger of the timer.

In some instances, the timer triggers measurement every 5 ms.

In some instances, analyzing the conditioned sample includes confirming that the measurement was performed within 10% of the total period of the periodic measurements.

In some instances, the machine is a turbine generator.

In some instances, the control processor controls a speed of the machine.

In some instances, the measurement data includes information associated with machine temperature, pressure, acceleration rate, and speed.

In some instances, the safety action is an emergency stop.

In some instances, the boundary processor isolates the control processor from the safety controller and sends the conditioned sample to the control processor using a proprietary protocol. In some implementations, the proprietary protocol is an Ethernet protocol.

Similar operations and processes may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer-implemented software embodied on tangible, non-transitory media that processes and transforms the respective data; some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts a block diagram illustrating a simplified system architecture for allowing a real-time controller to read signals from a safety controller.

FIG. 2 depicts an example timeline of control and safety operations for a machine.

FIG. 3 is a flowchart illustrating an example process for controlling a machine.

FIG. 4 is a schematic diagram of an example computer system.

Like reference numbers and designations in the various drawings indicate like elements.

### DETAILED DESCRIPTION

This disclosure describes a system and method for implementing real time control of a machine without requiring redundant sensing and signal conditioning. Many critical machines that require high reliability and safety use redundant control systems and safety systems. The control system can read one or more parameters related to operations of the machine and send control signals to adjust the monitored operation. In contrast, a safety system typically monitors a number of parameters, and, upon detecting a parameter exceeding a predetermined safety threshold, the safety system can send a safe command, or a shutdown command, in order to rapidly place the machine in a safe condition.

For example, if the machine is a turbine generator, the safety system can monitor internal turbine temperature, rotor speed, voltage, and frequency, and issue a shutdown command that trips or closes a supply valve to the turbine in the event that any of the monitored parameters exceed a safety threshold (e.g., over speed, over voltage, under frequency, over temperature, etc.). The control system, for example, can be a speed control system which monitors rotor speed and makes regular throttle adjustments to a different valve supplying fuel (or high pressure/energy fluid) to the turbine. In some implementations, each of the control systems and the safety system include their own sensor(s), signal conditioning circuits, logic, and communications pathways. However, because these systems are often monitoring similar or identical parameters (e.g., rotor speed), then it may be advantageous to use the same sensor(s) and signal conditioning circuit(s) for both the safety system and the control system, reducing overall system complexity and cost.

Additionally, safety systems are often externally certified by a third-party agency. Thus, changing components, or modifying the design of the safety system can be prohibitively expensive or time consuming. This disclosure describes a system and process that uses sensors and signal conditioning circuits already certified within a safety system, by adding a safety boundary which uses a separate processor and one-way communications from the safety system to a control system. The disclosed system and process enables a control system to use signal from the safety system's signal conditioner.

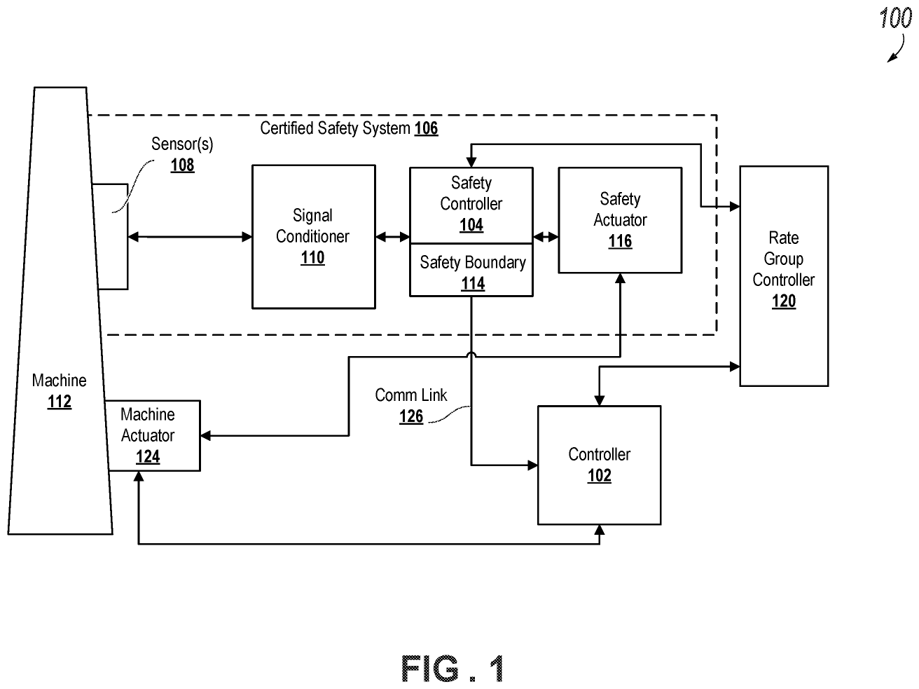

FIG. 1 is a block diagram illustrating a simplified system architecture 100 for allowing a real-time controller 102 to read signals from a safety controller 104. Safety controller 104 is part of a certified safety system 106 that includes sensor(s) 108, a signal conditioner 110, the safety controller 104 and safety boundary 114, and one or more safety actuators 116. In addition to the certified safety system 106, system 100 includes a controller 102, machine actuator 124, machine 112, and a rate group controller 120. Various components in system 100 communicate using communications links 126.

Certified safety system 106 can be a hardware and software device that has been certified by an external authority and is designed to be highly reliable and to rapidly place machine 112 in a safe condition if a dangerous scenario is detected. Certified safety system 106 can include one or more sensors 108, which can measure physical parameters associated with the machine such as rotational speed, voltage generated, frequency, phase angle, temperatures associated with different stages of the machine, pressures at the inlet and exhaust of the machine, fuel flow, exhaust flow, oil or lubricant flow, pressure, or temperature, and other parameters. In some implementations, sensors 108 measure additional parameters that are external to machine 112, such as ambient temperature, noise, pressure, or grid voltage, among other things. In some implementations, sensors 108 are redundant, in that there are two or more of each sensor, such that the failure of any single component will not result in a faulty measurement of machine 112.

In general, sensors 108 pass signals to a signal conditioner 110 which processes the data received from the sensors 108 for use in downstream analysis (e.g., safety analysis or control input development). Signal conditioner 110 includes logic and processing necessary to convert the raw data generated by sensors 108 into usable signals. Signal conditioner 110 can include, for example, filtering circuits such as passive or active low pass, high pass, or band pass filters. Signal conditioner 110 can further include averaging circuits, quantization circuits (e.g., sample and hold systems), anomaly or glitch filtering, scale and/or shift conversions, linearization, temperature compensation, and other processes. In some implementations the signal conditioner 110 processes/conditions the signal from sensors 108 in real-time, instantaneously, or near-instantaneously. For example, the total time between an event being detected by sensors 108, conditioned by signal conditioner 110, and arriving at safety controller 104 can be less than 1 ms, or otherwise designed to have no intentional delay in its propagation. In some implementations signal conditioner 110 is made up of one or more analog circuits. In some implementations the signal conditioner 110 is a digital signal conditioner, with a dedicated processor and clock. In some implementations signal conditioner 110 is a combination of analog and digital circuits. The signal conditioner 110 can be an analog circuit, for example, a resistive temperature detector (RTD) circuit that includes one or more calibrated components.

Safety controller 104 can receive or sample the conditioned signal and determine whether a safety action is required. In some implementations, the safety controller 104 is directed by a rate group controller 120, which synchronizes and provides timing signals to components of system 100. In some implementations, rate group controller 120 generates a timing signal that is read by various components in system 100 (e.g., controller 102 and safety controller 104). In some implementations, rate group controller 120 transmits command signals directly to safety controller 104 and controller 102, among other components. Safety controller 104 can monitor the conditioned signal that represents one or more operational parameters of machine 112, which can be a mechanical device such as a turbine generator, diesel engine, electric motor, or other device. If safety controller 104 detects a parameter is outside a predetermined threshold or has been outside the threshold for a predetermined time (e.g., the last three samples), the safety controller 104 can signal one or more safety actuators 116 to take a safety action.

Safety actuator 116 can generate a signal or command to close a valve, open a breaker, or otherwise mitigate the potential damage caused by the out of threshold parameters. For example, in an over speed condition, the safety actuator 116, can shut a solenoid operated fuel valve, cutting fuel flow to the machine 112, and deactivating the machine. In another example where a fire is detected, the safety actuator 116 can trigger a fire suppression system, opening a valve and releasing suppressant in the vicinity of the machine, while simultaneously stopping fuel flow to the machine 112. In another example, where an over current condition is detected, the safety controller 104 and safety actuator 116 can open a circuit breaker, protecting the machine 112 and downstream components from hazardous electrical current.

Safety boundary 114 is a dedicated system within the safety controller 104 of the certified safety system 106. Safety boundary 114 can include a dedicated processor, which receives the conditioned signal from signal conditioner 110, and transmits it to controller 102 via communications link 126. In some implementations the boundary processor of safety boundary 114 operates in parallel with a processor of the safety controller 104 and is electrically isolated from the rest of the safety controller 104. The boundary processor serves as a one-way access that pushes data from signal conditioner 110 to controller 102.

Communications link 126 can be a physical (e.g., wired) connection that has a dedicated one-way communications protocol from safety boundary 114 to controller 102. In some implementations, the communications link 126 uses a CAN bus type communications system, including using a proprietary communications protocol such as ISO 11898-2 or an SAE J1939 communications protocol. In some implementations, communications link 126 uses an Ethernet communications protocol.

Controller 102 receives the conditioned signal from safety boundary 114. In some implementations, the safety boundary 114 is configured to add little to no latency, such that signals propagate from sensor(s) 108 through the certified safety system 106 to controller 102 in real-time or near real-time (e.g., less than 1 ms, or less than 0.5 ms). Controller 102 additionally receives synchronization and/or timing signals from rate group controller 120. Using the same rate group controller 120 for both the safety controller 104 and controller 102 enables controller 102 to perform real-time or high-speed control based on the certified safety system's 106 sensed signals. In general controller 102 receives data pertaining to operational parameters of machine 112 and generates a command signal in order to operate machine 112. For example, controller 102 can receive a speed signal, compare that speed signal to a desired speed or set-point speed, and generate a command signal to send to machine actuator 124 in order to cause machine 112 to achieve the desired speed. Controller 102 can include one or more classical controllers such as a proportional-integral, or proportional-integral-derivative (PID) type controllers. In some implementations controller 102 includes one or more modern controllers such as fuzzy logic controllers, state space controllers, linear-quadratic regulators, or linear-quadratic-Gaussian controllers.

Controller 102 sends command signals to machine actuator 124 which can be one or more valves, switches, or other devices for controlling operations of machine 112. For example, where the controller 102 is controlling machine speed, the controller 102 can send a command signal to adjust a throttle valve within machine actuator 124, which adjusts fuel flow, and thus speed of the machine 112.

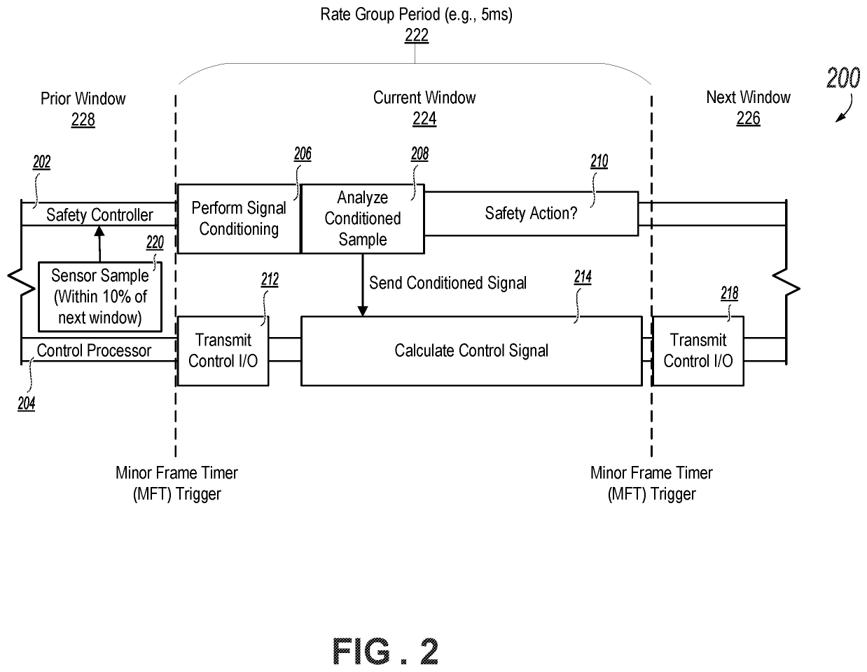

FIG. 2 depicts an example timeline 200 of control and safety operations for a machine. The illustrated timeline can be orchestrated and/or controlled by rate group timer 120 as described above with respect to FIG. 1. The safety controller's operations are represented by the top timeline 202, while the control processor's operations are represented by the bottom timeline 204. While illustrated as taking specific portions of the overall rate group period 222, the operations of safety controller and control processor can take longer, or shorter than illustrated.

The rate group period 222 is set according to the desired performance of the overall system (e.g., system 100 as described in FIG. 1). In general, the rate group period 222 represents the overall cyclic period for both the safety controller to sense and take safety action if necessary, and for the control processor to receive sensor data and adjust machine operations as necessary. In the illustrated example, the rate group period 222 is set for 5 ms, however other times are possible such as 10 ms, 1 ms, 50 ms or others.

At the beginning of the rate group period 222 a minor frame timer (MFT) trigger is received, and the safety controller begins performing signal conditioning 206 on a sensor sample that has been collected within 10% of the rate group period 222 of the trigger (220). For example, where the rate group period is 5 ms, the sensor sample is collected at the time of the MFT trigger within 0.5 ms or 500 μs. The signal conditioning is then analyzed by the safety controller (208). During this analysis, the conditioned signal is sent to the control processor which begins calculating a control signal (214).

After analyzing the conditioned sample, the safety controller determines whether a safety action is required (210). If a safety action is required, a safety action command is sent to an actuator associated with the machine being controlled, in order to place the machine in a safe condition. If no safety action is required, the safety controller can idle until the next MFT trigger, where a new sample and signal conditioning will be performed.

Meanwhile, at the beginning of the rate group period 222 the control processor sends control input/outputs (I/O) from the prior window 228 (212). In some implementations, this control I/O can be a throttle command that serves to manipulate a motor operated valve in order to adjust the speed of the machine. The control I/O can be, for example, throttle commands, cooling commands, excitation or power generation commands, among other things for operating the machine.

Upon receipt of the conditioned signal from the safety controller, the control processor then begins calculating the next control signal (214). As described above, this calculation can involve both classical and modern control calculations, and in some cases, can include previous samples from prior window 228, as well as previous control I/O signals send. Once the control signal is calculated, the control processor waits for the next MFT trigger and transmits the calculated signals in the next window 226.

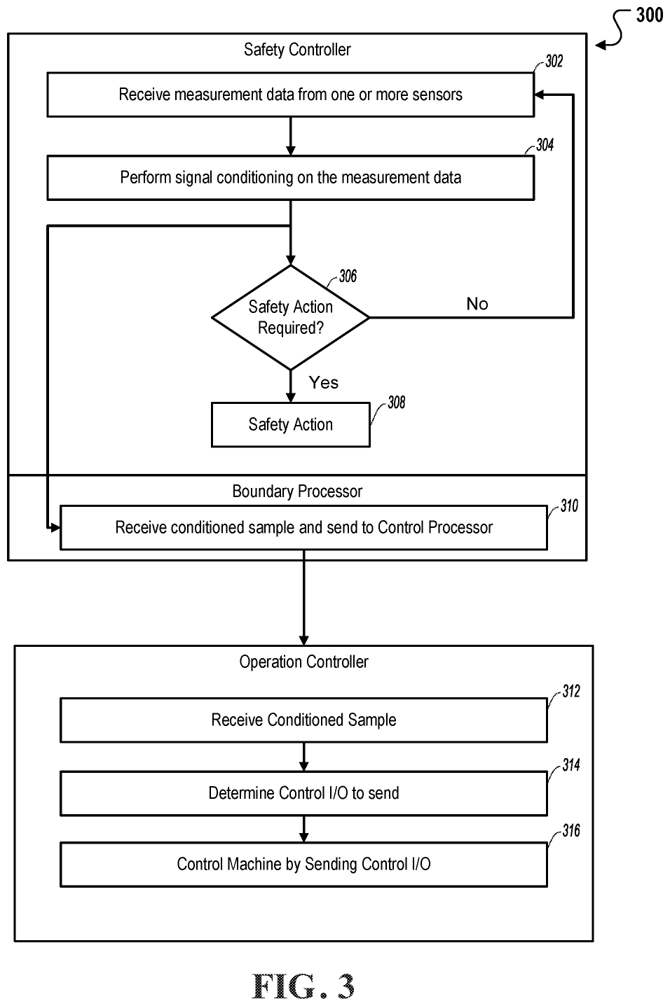

FIG. 3 is a flowchart illustrating an example processes 300 for controlling a machine. It will be understood that process 300 may be performed, for example, by any suitable system, environment, software, and hardware, or a combination of systems, environments, software, and hardware as appropriate. In some instances, process 300 can be performed by the system as described in FIG. 1, or portions thereof, and further described in FIG. 2, as well as other components or functionality described in other portions of this description. In other instances, process 300 may be performed by a plurality of connected components or systems. Any suitable system(s), architecture(s), or application(s) can be used to perform the illustrated operations.

At 302, the safety controller receives measurement data from one or more sensors. The sensors detect parameters associated with the machine being controlled, such as rotational speed, internal temperature, ambient temperature, noise, inlet pressure, exhaust pressure, internal pressure, fuel flow, exhaust flow, vibrations or accelerations, voltage, frequency, or other parameters. In some implementations the sensors continuously, or near continuously measure parameters, and the safety controller polls them periodically to receive a sample in the form of measurement data. The measurement data can be analog signals (e.g., voltages and currents) from the sensors, or digital signals (e.g., serial data, fiber optics, etc.).

At 304, the measurement data is conditioned. Signal conditioning can include using one or more filters, such as band-pass filters, high-pass filters, and/or low-pass filters. Additional signal conditioning can include scaling or amplifying of the signal, denoising, shifting (e.g., voltage biasing), averaging, linearization, temperature compensation, or other signal conditioning.

At 306, the conditioned signal is analyzed to determine whether a safety action is necessary. In some implementations this analysis identifies whether any of the measured parameters are outside of a predetermined threshold. For example, a speed parameter may have an over-speed threshold and an under-speed threshold, if the measured speed is above the over-speed threshold, or below the under-speed threshold, then a safety action is required and process 300 proceeds to 308. If a safety action is not required (e.g., all the measured data is within acceptable limits) then process 300 can return to 302, where more measurement data is received. In some implementations, process 300 cycles through 302 periodically, for example, in response to an external synchronization signal provided by a rate group controller (e.g., rate group controller 120 of FIG. 1).

At 308, if a safety action is required, the safety controller takes the associated safety action. Safety actions can include, but are not limited to, a signal or command to close a valve, open a breaker, activate a fire suppression system, energize alarms, close doors or safety barriers, shut down systems, or other mitigating actions.

The conditioned signal is further passed to a boundary processor which receives the conditioned sample and sends it to the control processor at 310. The boundary processor can be a separate integrated circuit that establishes a dedicated one-way communications path from the safety controller, which is typically part of a third-party certified system, and the operations controller. In some implementations, the boundary processor acts as a repeater, broadcasting the conditioned signal. In some implementations, the boundary processor performs additional operations, such as adding metadata or timing information to the conditioned sample.

At 312, the operation controller receives the conditioned sample from the boundary processor. In some implementations, the boundary processor sends the sample to the operation controller in response to a poll or request from the operation controller. In some implementations, the boundary processor just broadcasts or “pushes” the conditioned sample to a buffer of the operation controller.

At 314, the operation controller determines a control signal or input/output to send to the machine actuator. This can be a speed signal, a throttle command, an excitation command, or other signal, in order to adjust the operation of the machine to achieve desired operational parameters.

At 316, the machine is controlled by the operation controller via the control I/O generated at 314. This control loop can include both classical and modern controllers such as proportional-integral or proportional-integral-derivative (PID) type controllers, fuzzy logic controllers, state space controllers, linear-quadratic regulators, or linear-quadratic-Gaussian controllers.

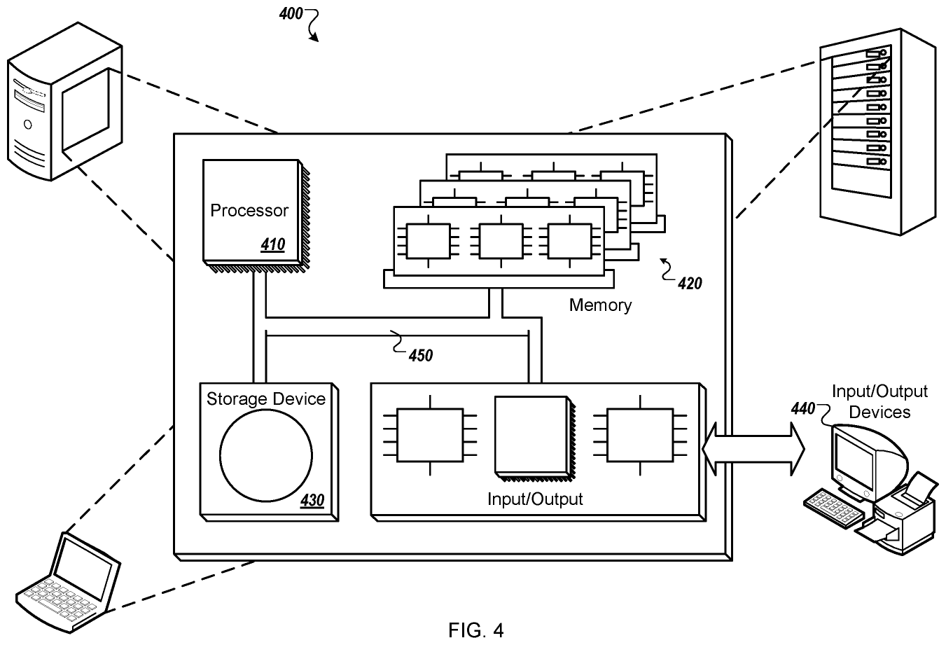

FIG. 4 is a schematic diagram of an example computer system 400 (e.g., a data processing apparatus). The system 400 can be used for the operations described in association with the process 300 according to one implementation.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 (e.g., a non-transitory memory) stores information within the system 400. In one implementation, the memory 420 is a computer-readable medium. In one implementation, the memory 420 is a volatile memory unit. In another implementation, the memory 420 is a non-volatile memory unit.

The storage device 430 (e.g., non-transitory storage) is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, this concept is not limited to aircraft engine control or industrial turbine control; it would be applicable to any appropriate frequency signal derived from a variable reluctance sensor. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A machinery control system comprising:
a sensor configured to measure an operating characteristic of a machine;
a safety controller in communication with the sensor, the safety controller comprising a dedicated boundary processor, wherein the safety controller is in communication with a control processor through the boundary processor which isolates operations of the control processor from the safety controller, and wherein the safety controller is configured to perform operations comprising:
receiving, from the sensor, measurement data;
performing signal conditioning on the measurement data to generate a conditioned sample;
analyzing the conditioned sample and determining whether to take a safety action; and
sending the conditioned sample to the boundary processor for transmission to the control processor;
the control processor configured to perform operations comprising:
receiving the conditioned sample; and
controlling one or more operations of the machine based on the conditioned sample.

2. The system of claim 1, wherein the sensor is triggered by a timer to perform a measurement periodically.

3. The system of claim 2, wherein the control processor is configured to wait to control one or more operations of the machine until a next trigger of the timer.

4. The system of claim 2, wherein the timer triggers the measurement every 5 ms.

5. The system of claim 2, wherein analyzing the conditioned sample comprises confirming that the measurement was performed within 10% of a total period of the periodic measurements.

6. The system of claim 1, wherein the operations of the safety controller are configured to occur during a scheduled period, and wherein the conditioned sample is sent to the boundary processor and transmitted to the control processor within the first 10% of the scheduled period.

7. The system of claim 1, wherein the machine is a turbine generator.

8. The system of claim 1, wherein the control processor controls a speed of the machine.

9. The system of claim 1, wherein the measurement data comprises information associated with machine temperature, pressure, acceleration rate, and speed.

10. The system of claim 1, wherein the safety action is an emergency machine stop.

11. The system of claim 1, wherein the boundary processor isolates the control processor from the safety controller, and wherein the boundary processor sends the conditioned sample to the control processor using a proprietary protocol.

12. A method comprising:
receiving, at a safety controller and from a sensor configured to measure an operating characteristic of a machine, measurement data;
performing, by the safety controller, signal conditioning on the measurement data to generate a conditioned sample;
analyzing, by the safety controller, the conditioned sample and determining whether to take a safety action; and
sending the conditioned sample to a boundary processor that isolates operations of a control processor from the safety controller for transmission to the control processor;
receiving, by the control processor and from the boundary processor, the conditioned sample; and
controlling, by the control processor, one or more operations of the machine based on the conditioned sample.

13. The method of claim 12, wherein the sensor is triggered by a timer to perform a measurement periodically.

14. The method of claim 13, wherein the control processor is configured to wait to control one or more operations of the machine until a next trigger of the timer.

15. The method of claim 13, wherein the timer triggers the measurement every 5 ms.

16. The method of claim 13, wherein analyzing the conditioned sample comprises confirming that the measurement was performed within 10% of a total period of the periodic measurements.

17. The method of claim 12, wherein the operations of the safety controller are configured to occur during a scheduled period, and wherein the conditioned sample is sent to the boundary processor and transmitted to the control processor within the first 10% of the scheduled period.

18. A machinery control system comprising:
a sensor configured to measure an operating characteristic of a machine;
a safety controller in communication with the sensor, the safety controller comprising a dedicated boundary processor, wherein the safety controller is in communication with a control processor through the boundary processor which isolates operations of the control processor from the safety controller, and wherein the safety controller is configured to perform operations comprising:
receiving, from the sensor, measurement data;
performing signal conditioning on the measurement data to generate a conditioned sample;
analyzing the conditioned sample and determining whether to take a safety action; and
sending the conditioned sample to the boundary processor for transmission to the control processor, wherein the control processor controls one or more operations of the machine based on the conditioned sample.

19. The system of claim 18, wherein the sensor is triggered by a timer to perform a measurement periodically.

20. The system of claim 19, wherein the control processor is configured to wait to control one or more operations of the machine until a next trigger of the timer.
